(19) United States
(12) Patent Application Publication
(10) Pub. No.: US 2016/0009109 A1
(43) Pub. Date: Jan. 14, 2016

(54) PRINT-TARGET FABRIC SUPPORTING DEVICE, PRINTING APPARATUS AND MANUFACTURING METHOD FOR PRINTING ON FABRIC

(71) Applicant: SEIKO EPSON CORPORATION, Tokyo (JP)

(72) Inventor: Kenji YANAGISHITA, Matsumoto-shi (JP)

(21) Appl. No.: 14/859,949

(22) Filed: Sep. 21, 2015

Related U.S. Application Data
(63) Continuation of application No. 13/659,562, filed on Oct. 24, 2012.

(30) Foreign Application Priority Data
Oct. 28, 2011 (JP) 2011-236938

(51) Int. Cl. B41J 11/06; B41J 3/407

(52) U.S. Cl. CPC B41J 11/06; B41J 3/4078

(57) ABSTRACT

A print-target fabric supporting device includes: a holding member that holds a print-target fabric having a cylindrical body portion while being inserted into the cylindrical body portion of the print-target fabric; a base unit on which the holding member holding the print-target fabric is fitted; and a print surface formation portion that is provided in at least any one of the holding member and the base unit so as to form a print surface onto which ink is discharged while the holding member being fitted on the base unit.

### CROSS-REFERENCE TO RELATED APPLICATIONS

The present application is a Continuation of U.S. patent application Ser. No. 13/659,562, filed on Oct. 24, 2012, which claims priority to Japanese Patent Application No. 2011-236938, filed on Oct. 28, 2011, which applications are incorporated by reference herein.

### BACKGROUND

1. Technical Field

The present invention relates to printing apparatuses that perform printing with an ink jet technique or the like on cloth, that is, on print-target fabric, and constituent elements thereof, and in particular relates to a print-target fabric supporting device to support print-target fabric having a cylindrical body portion such as a T-shirt and a manufacturing method of printed fabric.

2. Related Art

Printing apparatuses that print a desired image on a surface of print-target fabric having a cylindrical body portion such as a T-shirt by discharging different colors of ink from ink discharge heads have been developed and used.

In this case, setting operation in which cloth to be printed on is fixed on a set tray (print-target fabric supporting device) with its wrinkles being smoothed is carried out in advance before ink jet printing. Various types of print-target fabric supporting devices that make the setting operation easy to be done are proposed as described in JP-A-2007-31888, JP-A-2003-312069 and JP-A-2005-230147.

In JP-A-2007-31888, a print-target fabric supporting device is disclosed in which a stretcher in a contracted state is inserted into the inside of a body portion of a T-shirt and thereafter expanded to stretch the body portion of the T-shirt outward so that wrinkles in the T-shirt are smoothed.

In JP-A-2003-312069, a print-target fabric supporting device is disclosed in which a body portion of a T-shirt is set to cover a platen and a support plate that are connected to each other with a pin, and then the body portion thereof is pressed from above using a frame member so as to smooth out wrinkles in the T-shirt.

Meanwhile, in JP-A-2005-230147, a print-target fabric supporting device is disclosed in which a sheet-formed cloth is pinched between an inner frame and an outer frame whose perimeters can be varied so as to smooth wrinkles in the cloth. By fitting the inner frame onto a protrusion formed on a platen (print-target fabric supporting device) of an ink jet printing apparatus, the print-target fabric held by the inner and outer frames is fixed on the platen.

However, the print-target fabric supporting device disclosed in JP-A-2007-31888 has a complicated structure and is disadvantageous in workability because operations of several steps are needed to be carried out to set the stretcher in the T-shirt.

Further, in JP-A-2003-312069, since wrinkles in the print-target fabric are removed using the frame member that presses the print-target fabric from above, improvement in workability can be expected to some extent. However, it is not easy to insert a T-shirt into a narrow space between a platen tray and the platen and support plate integrated with a pin. Therefore, the supporting device disclosed in JP-A-2003-312069, similar to the supporting device disclosed in JP-A-2007-31888, is disadvantageous in workability.

Furthermore, in JP-A-2005-230147, since the print-target fabric held by the inner and outer frames is fixed on a base unit by fitting the inner frame onto the protrusion which is formed on the platen, improvement in workability can be expected to some extent. However, the operation of fitting the inner frame onto the protrusion is not used for removing the wrinkles in the print-target fabric. Therefore, the supporting device disclosed in JP-A-2005-230147 cannot necessarily be a print-target fabric supporting device that is appropriate for a print-target fabric having a cylindrical body portion such as a T-shirt or the like.

Still further, with a structure in which a print-target fabric is placed and spread on a flat base unit 105 so as to remove wrinkles, as shown in FIG. 9, an avoidance-recess 103 or the like is needed to be formed in a support platform 101 to avoid interference with a print-target fabric T. This can cause a problem that design restrictions against stiffness in designing the support platform 101 or the like are generated.

### SUMMARY

An advantage of some aspects of the invention is to provide a print-target fabric supporting device that enhances workability of operation for setting print-target fabric, a printing apparatus including the stated print-target fabric supporting device, and a manufacturing method for printing on a fabric.

A print-target fabric supporting device according to a first aspect of the invention includes: a holding member that holds a print-target fabric having a cylindrical body portion while being inserted into the cylindrical body portion of the print-target fabric; a base unit on which the holding member is fitted in a state holding the print-target fabric; and a print surface formation portion that is provided at least in any one of the holding member and the base unit so as to form a print surface onto which ink is discharged while the holding member being fitted on the base unit.

Here, “print-target fabric” means “cloth” on which printing is carried out and includes natural fibers such as cotton, silk, wool and so on, chemical fibers such as nylon and the like, or composite fiber materials made by mixing those fibers such as woven fabric, knitted fabric, non-woven fabric and so on; note that the print-target fabric includes both a long-length material that is wound up in a roll and a material that is cut into a predetermined length. Further, the print-target fabric includes: clothes having experienced sewing such as a T-shirt and the like; various kinds of furniture having experienced sewing such as a handkerchief, a scarf, a towel, a curtain, a sheet, a bedcover and so on; and cloth before/after being cut that is prepared as a part to be sewed.

The invention is intended to be applied to a “print-target fabric” that has a cylindrical body portion such as a T-shirt among the materials or clothes mentioned above.

According to the first aspect, a holding member is made to wear a print-target fabric such as a T-shirt or the like so as to hold the print-target fabric, and a print surface onto which ink is discharged is formed by fitting the holding member on a base unit while the print-target fabric being held by the holding member. Accordingly, workability of setting operation of print-target fabric can be improved.

In addition, it is not necessary to directly operate the base unit, which is usually heavy in weight, in the setting operation, and what is necessary is to make the holding member wear the print-target fabric and then fit the holding member on the base unit. Since it is possible to reduce the weight of the holding member, workability of the setting operation can be improved due to the reduction in weight thereof. Safety of the setting operation of print-target fabric is enhanced because the setting of the print-target fabric is carried out by causing the holding member to wear the print-target fabric.

Here, if a configuration is employed such that the print surface formation portion is not formed in any one of the holding member and the base unit but formed in both so as to form a print surface onto which ink is discharged while the holding member being fitted on the base unit, the print surface can be formed by making the holding member and the base unit flushed with each other.

Further, design restrictions against stiffness of the supporting device are unlikely to be generated. That is, in the case where a print-target fabric is directly set on the base unit, an avoidance-recess or the like is needed to be formed in a support platform or the like that supports the base unit so as to avoid interference with the print-target fabric. However, by setting a print-target fabric on the holding member in a manner in which the print-target fabric is put on the holding member, the avoidance-recess or the like becomes unnecessary. This makes it easy to carry out stiffness design of the support platform or the like.

A print-target fabric supporting device according to a second aspect of the invention is a device such that the holding member of the first aspect is configured so as to be detachable.

According to the second aspect, because a print-target fabric can be mounted on the holding member in a worn state where the holding member is detached from the base unit, mounting operation thereof can be carried out with ease and it is possible to mount a print-target fabric on the holding member beforehand in preparation for the setting operation. Therefore, the setting operation can be smoothly carried out particularly when a large number of print-target fabrics are needed to be printed on.

A print-target fabric supporting device according to a third aspect of the invention is a device such that the holding member of the first aspect is so provided as to be capable of swinging relative to the base unit.

According to the third aspect, the holding member can be swung and placed at a position where a print-target fabric can be mounted with ease, thereafter the mounting operation thereof can be carried out. Accordingly, workability of operation of mounting/dismounting a print-target fabric can be improved.

A print-target fabric supporting device according to a fourth aspect of the invention is a device such that the holding member of the second aspect includes a hanger portion that can hang a print-target fabric which is in a state of being held.

According to the fourth aspect, it is possible to prepare a lot of print-target fabrics in a state in which the print-target fabrics are mounted and hung on the holding members in advance. In addition, since the holding member and the print-target fabric can be moved simultaneously by handling the hanger portion, the moving operation thereof can be carried out with ease as well.

A print-target fabric supporting device according to a fifth aspect of the invention is a device such that, in any one of the first through fourth aspects, the base unit is a sheet-like element that includes a fitting protrusion that has a flat surface serving as the print surface formation portion and engagement border portions that are formed at a position receding from the position of the flat surface on at least two sides opposed to each other in the perimeter of the fitting protrusion; and the holding member is a frame element that includes a window portion to be fitted onto the fitting protrusion, engagement step portions to be engaged with the engagement border portions, and contact portions that make contact with inner surfaces at both ends opposed to each other of a print-target fabric which is being held. Note that the window portion, the engagement step portions and the contact portions are arranged on at least a pair of two sides opposed to each other of the frame element.

In this specification, “window portion” also means a structure with one side thereof open, that is, not all the perimeter thereof is enclosed (in a case of a square window, a structure with one side removed among the four sides).

Further, “sheet-like element” means a structure that is capable of having a flat surface serving as the print surface formation portion in this specification. A solid body, a hollow body and the like are general examples of such structure. Note that holes may be provided in a portion that will not prevent the formation of the flat surface.

Furthermore, “frame element” is a structure that surrounds a certain area, and in which an opening such as a hollow space, a window portion, a cutout or the like is formed in part of surfaces configuring the outer shape thereof in general. Note that the “frame element”, just like the “window portion”, includes a structure with one side open, that is, not all the perimeter thereof is enclosed (in a case of a square frame element, a structure with one side removed among the four sides).

According to the fifth aspect, by making the base unit be a sheet-like element and making the holding member be a frame element, it is possible to use the upper surface of the fitting protrusion of the base unit as the print surface formation portion for supporting a print-target fabric as well as forming a flat print surface onto which ink is discharged.

In addition, by making the holding member be a frame element, the holding member becomes lighter in weight, thereby making it easy to move the holding member, mount a print-target fabric thereon, and so on.

Further, since the engagement step portions and the contact portions, which play a role in holding action and stretching action to a print-target fabric, are set to be located at two sides opposed to each other in a direction in which wrinkles in the print-target fabric are smoothed out, the holding action and wrinkle-smoothing action can be efficiently applied to a print-target fabric with the holding member in a simple structure.

A print-target fabric supporting device according to a sixth aspect of the invention is a device such that, in any one of the first through fourth aspects, the base unit includes a fitting protrusion and engagement border portions that are formed at a position receding from the top position of the fitting protrusion on at least a pair of two sides opposed to each other in the perimeter of the fitting protrusion; and the holding member is a sheet-like element that includes a flat surface serving as the print surface formation portion, a recess to be fitted on the fitting protrusion, engagement step portions to be engaged with the engagement border portions, and contact portions that make contact with inner surfaces at both ends opposed to each other of a print-target fabric which is being held. Note that the flat surface, the recess, the engagement step portions and the contact portions are arranged on at least a pair of two sides opposed to each other of the sheet-like element.

According to the sixth aspect, the holding member, which is a sheet-like element, includes a print surface formation portion itself to form a flat print surface onto which ink is discharged. With this structure, the same action effect as that of the fifth aspect can be obtained.

A print-target fabric supporting device according to a seventh aspect of the invention is a device such that the contact portions of the fifth or sixth aspect are so configured as to be capable of being extended in a direction in which wrinkles in the print-target fabric are smoothed out.

According to the seventh aspect, as the size of a print-target fabric is larger, the amount of extension of the contact portions can be made larger, meanwhile as the size of a print-target fabric is smaller, the amount of extension of the contact portions can be made smaller. This makes it possible to correspond to print-target fabrics of a plurality of sizes with a single base unit and a single holding member.

A printing apparatus according to an eighth aspect of the invention is a printing apparatus that includes a set tray having a print surface formation portion to form a flat print surface where ink is discharged onto a set print-target fabric; the set tray is the print-target fabric supporting device according to any one of the first through seventh aspects.

According to the eighth aspect, the printing apparatus can obtain action effects corresponding to the first through seventh aspects.

A manufacturing method of a printed fabric according to a ninth aspect of the invention is a method in which the printed fabric is manufactured using the printing apparatus according to the eighth aspect.

According to the ninth aspect, action effects corresponding to the first through seventh aspects can be obtained in the manufacturing of the printed fabric.

### BRIEF DESCRIPTION OF THE DRAWINGS

The invention will be described with reference to the accompanying drawings, wherein like numbers reference like elements.

FIG. 1 is a perspective view of a general configuration of an ink jet printing apparatus according to a first embodiment of the invention.

FIG. 2 is an exploded perspective view of a print-target fabric supporting device according to the first embodiment of the invention, illustrating a state in which a print-target fabric is being mounted.

FIG. 3 is a perspective view of the print-target fabric supporting device according to the first embodiment of the invention, illustrating a state in which the print-target fabric has been completely held.

FIG. 4 is a cross-sectional view of the print-target fabric supporting device according to the first embodiment of the invention taken along the line IV-IV in FIG. 3, illustrating the state in which the print-target fabric has been completely held.

FIGS. 5A and 5B are enlarged cross-sectional views illustrating an example of the principal portion of an extension mechanism of a contact portion of a print-target fabric supporting device according to a second embodiment of the invention.

FIGS. 6A and 6B are enlarged side views illustrating another example of the principal portion of the extension mechanism of the contact portion of the print-target fabric supporting device according to the second embodiment of the invention.

FIG. 7A is a plan view of a print-target fabric supporting device according to a third embodiment of the invention, and FIG. 7B is an enlarged cross-sectional view of the principal portion thereof.

FIG. 8A is a plan view of a print-target fabric supporting device according to a fourth embodiment of the invention, and FIG. 8B is an enlarged cross-sectional view of the principal portion thereof.

FIG. 9 is a cross-sectional side view of an example of a print-target fabric supporting device of the past technique, indicating a problem that occurs in the past print-target fabric supporting device.

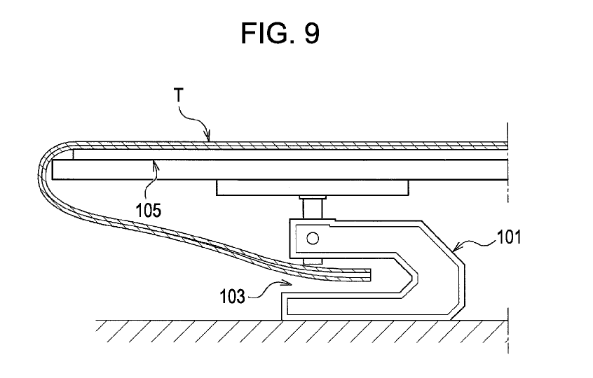

### DESCRIPTION OF EXEMPLARY EMBODIMENTS

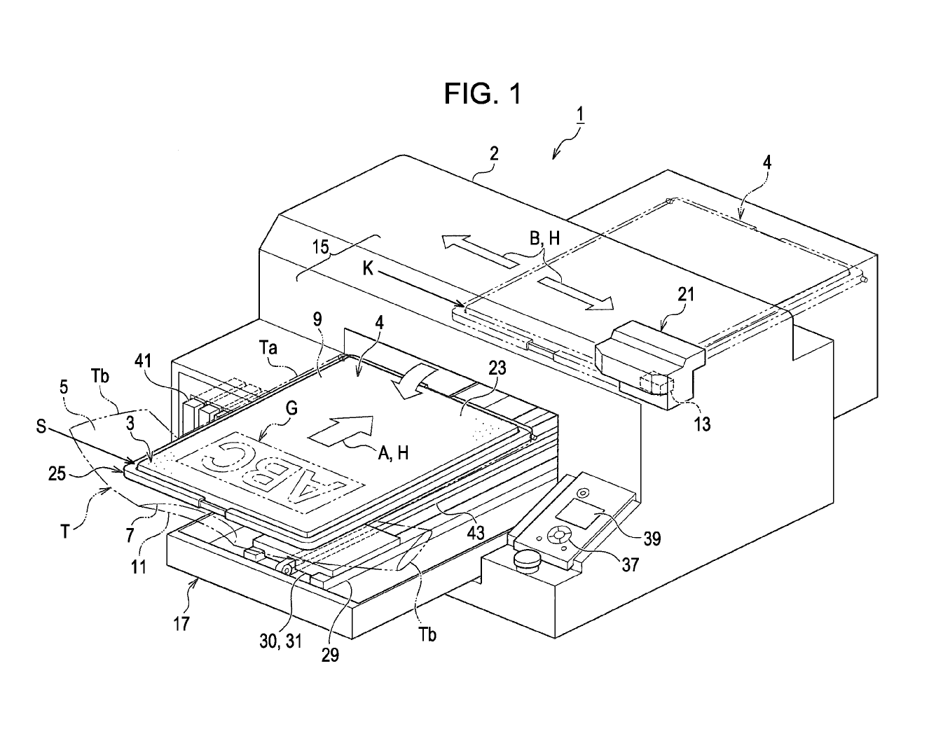

First, an outline of the overall configuration of an ink jet printing apparatus, which is an example of a printing apparatus of the invention, will be described below with reference to FIG. 1.

In the following description, a T-shirt in which a body portion Ta and sleeve portions Tb are cylindrically sewed will be cited and explained as an example of a print-target fabric (hereinafter, also called “cloth”) T, where a surface on the outer side of the T-shirt on which a print image G is formed is referred to as an outer surface 5, a surface on the inner side thereof is referred to as an inner surface 7, a surface that serves as a print surface and is located on the front side of the T-shirt when the T-shirt is held is referred to as a first surface 9, and a surface that serves as a supporting surface located on the reverse side thereof which is opposite to the first surface 9 is referred to as a second surface 11.

An ink jet printing apparatus 1 according to the invention includes a print-target fabric supporting device 4 configured to be appropriate for setting a print-target fabric T having a cylindrical body portion Ta on a base unit 3.

In this ink jet printing apparatus 1, in addition to the print-target fabric supporting device 4, a movement unit 17 is provided that loads the print-target fabric supporting device 4 thereon and moves it back and forth along a transport direction A between a set position S at which the print-target fabric T is set and a print start position K at a deep side with a print execution region 15 present therebetween.

The movement unit 17 is configured by a support base 29 extending in the transport direction A, a support platform 31 integrated with a slider 30 that moves back and forth along the transport direction A at the center of the right-and-left direction of the support base 29, and a driving mechanism using a timing belt 43 that drives the support platform 31. Note that the support platform 31 mentioned above is an example of a member provided on the support base 29.

A base unit 3, which will be described later, is attached to the upper portion of the support platform 31 via a connection mechanism (not shown).

An ink discharge head 13 that carries out printing on the first surface 9 of a print-target fabric T set on the print-target fabric supporting device 4 by discharging different colors of ink is disposed above the print execution region 15.

The ink discharge head 13 is installed in a carriage 21 that moves back and forth in the width direction of a main apparatus unit 2 as a scanning direction B which intersects with the transport direction A of the print-target fabric T. Further, the ink discharge head 13 is so configured as to move back and forth in the scanning direction B being integrated with the carriage 21 so that printing (ink jet printing) can be carried out by the ink discharge head.

At the left side of the main apparatus unit 2 when viewed from the front side, ink cartridges 41 are provided to supply different colors of ink to the ink discharge head 13 via appropriate tubes. Further, at the right side of the main apparatus unit 2 when viewed from the front side, an operation button 37 for executing various kinds of operations and a display unit 39 that displays set information regarding the ink jet printing, various kinds of messages and so on, are provided.

### First Embodiment

### See FIG. 1 Through FIG. 4

The print-target fabric supporting device 4 according to the invention includes: a holding member 25 that holds a print-target fabric T having a cylindrical body portion Ta while being inserted into the cylindrical body portion Ta of the print-target fabric T so as to stretch the print-target fabric T; the base unit 3 to which the holding member 25 holding the print-target fabric T is fitted; and a print surface formation portion 23 that is provided in the base unit 3 and forms a flat print surface onto which ink is discharged while the holding member 25 being fitted to the base unit 3.

The embodiment is configured so that a tension force F is exerted on the first surface 9 of the print-target fabric T by making use of a change in relative position between the base unit 3 and the holding member 25 in a fitting direction C.

Further, in this embodiment, the holding member 25A is connected to a bearing member (not shown) of the base unit 3A in a rotatable manner via a rotational shaft 27.

The base unit 3A is configured of a sheet-like element that includes: a fitting protrusion 45 which is formed in a thick rectangular plate-like shape and protrudes upward in the fitting direction C across a wide area at the center portion of the sheet-like element; and engagement border portions 47 which are formed in an outside flange shape sticking outward in the horizontal direction at the lower portion of the four perimeter sides of the fitting protrusion 45.

A flat upper surface of the fitting protrusion 45 is, in principle, the print surface formation portion 23 that supports the second surface 11 of the print-target fabric T.

The holding member 25A is configured of a rectangular frame element that surrounds four sides of an area where a rectangular window portion 49 which is fitted onto the fitting protrusion 45 of the base unit 3A is formed at the center thereof.

Four frame components 55 including engagement step portions 51 and contact portions 53 in an integrated manner are disposed at four sides of the holding member 25A; the engagement step portions 51 are formed in an inside flange shape and engage with the engagement border portions 47 of the base unit 3A from above in the fitting direction C, while the contact portions 53 make contact with the inner surface 7 at two pairs of both end sides opposed to each other of the print-target fabric T which is being held.

The rotational shafts 27 that are fitted into the bearing member (not shown) are provided at both ends in the width direction of the frame component 55A while sticking outward in the width direction thereof. Note that the frame component 55A is located at a rotation base side among the four frame components 55.

Furthermore, grips 57, 57 that serve as handholds when the holding member 25 is swung are formed at the center portion of the frame component 55A at the rotation base side and the center portion of the frame component 55B at a rotation free end side which is opposite to the frame component 55A, respectively.

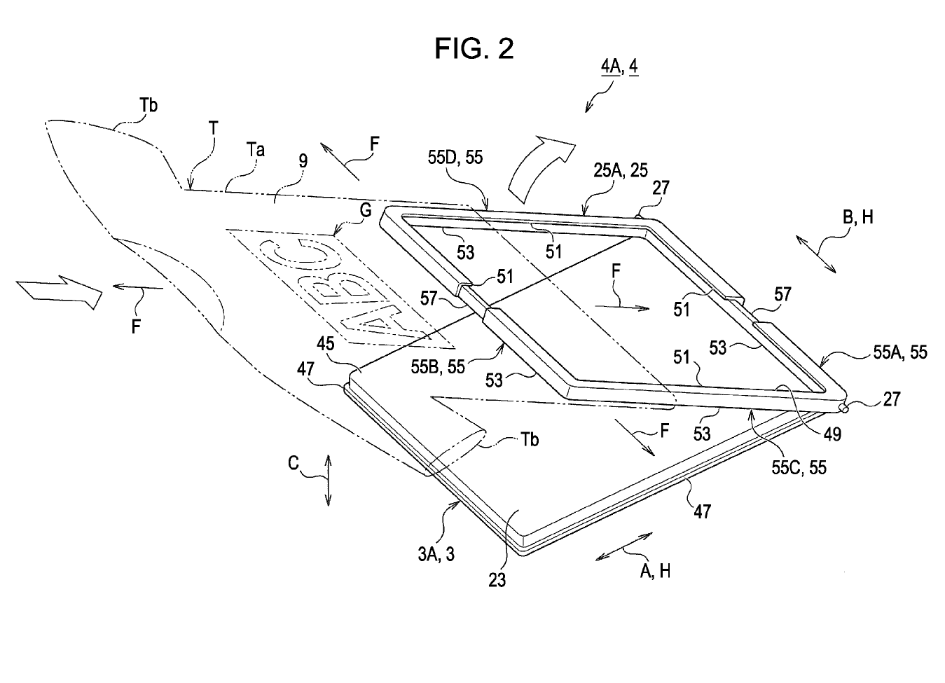

Then, in the case where a print-target fabric T is held using the print-target fabric supporting device 4A of the embodiment configured in this manner described above, the holding member 25A is rotated at an angle such that the print-target fabric T can be mounted with ease as shown in FIG. 2. Thereafter, the print-target fabric T is mounted in a manner such that the print-target fabric T moves with an opening of the body portion Ta thereof first so as to cover the holding member 25A starting from the frame component 55B side at the rotation free end side.

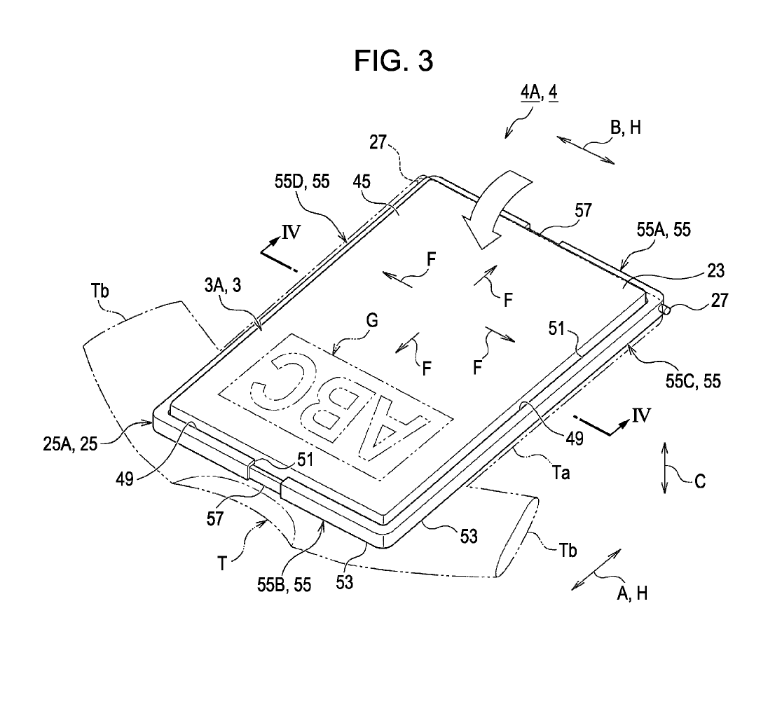

Upon completion of mounting the print-target fabric T on the holding member 25A, the holding member 25A is swung downward to the front side as shown in FIG. 3 so that the holding member 25A and the base unit 3A are overlapped each other.

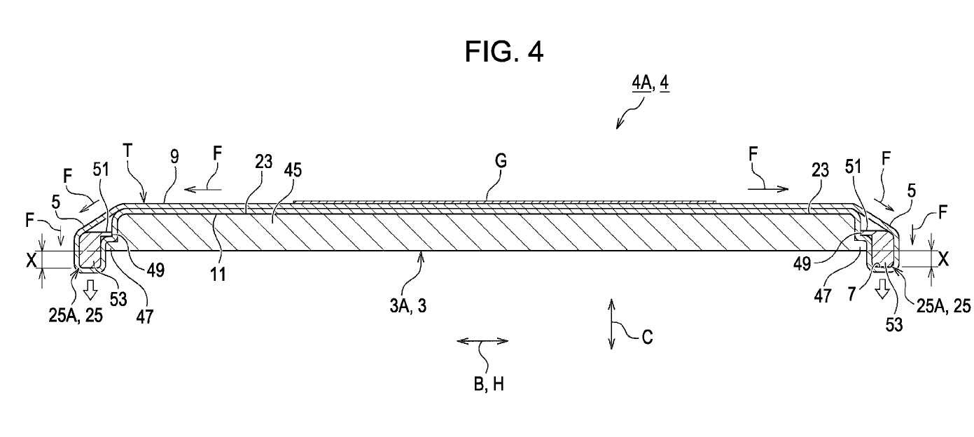

In this state, as shown in FIG. 4, the fitting protrusion 45 of the base unit 3A is fitted into the window portion 49 of the holding member 25A, and the engagement step portions 51 of the holding member 25A and the engagement border portions 47 of the base unit 3A engage with each other while part of the print-target fabric T being pinched between the lower surface of the engagement step portions 51 and the upper surface of the engagement border portions 47.

At this time, the holding member 25A moves downward and stops at a position which is lower than the print surface formation portion 23 of the base unit 3A in the fitting direction C by a displacement amount indicated by symbol X as shown in FIG. 4.

With this, tension forces F indicated by the arrows in FIG. 4 are exerted on the first surface 9 of the print-target fabric T and the outer surfaces 5 at both ends thereof, which continue from the first surface 9, so that the print-target fabric T is held in a state where wrinkles having been generated in the first surface 9 thereof are removed.

According to the print-target fabric supporting device 4A of the embodiment configured in this manner described above, since the holding member 25, which is light in weight and the position thereof can be easily changed, is made as a fabric-mounting member on which a print-target fabric T is mounted, it is possible to enhance workability of setting operation of the print-target fabric T and carry out printing on a large number of fabrics.

In addition, since the fabric-mounting member mentioned above becomes light in weight, the workload of setting operation of the print-target fabric T is lessened and safety of the setting operation is enhanced. Furthermore, by not using the base unit 3A but using the holding member 25 as the fabric-mounting member, an avoidance-recess or the like in order for the support platform 31 or the like to avoid interference with a print-target fabric T is not needed and stiffness design of the support platform 31 and the like becomes easier as a result.

Further, when printed fabrics are manufactured using the printing apparatus 1 described above, the printed fabrics can be manufactured with better workability.

### Second Embodiment

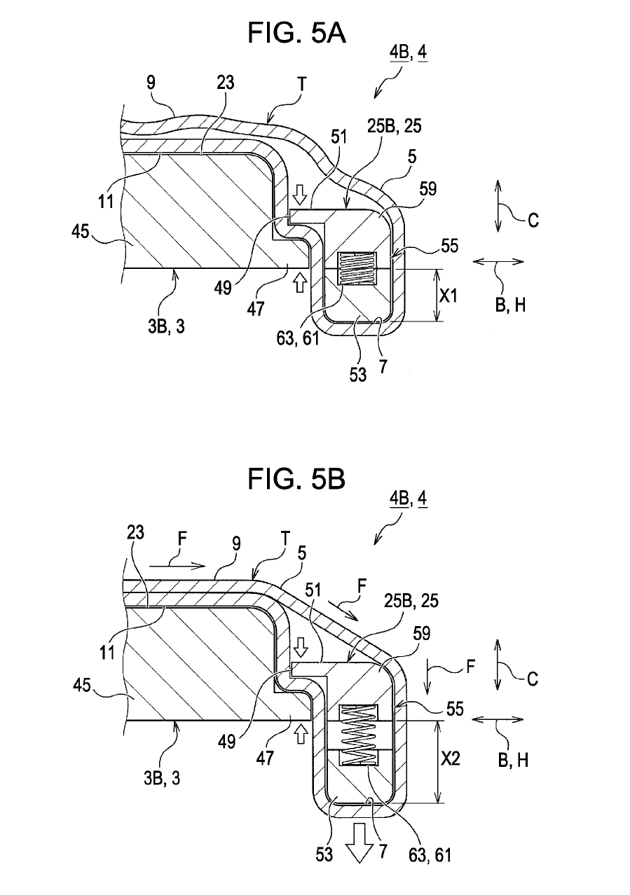

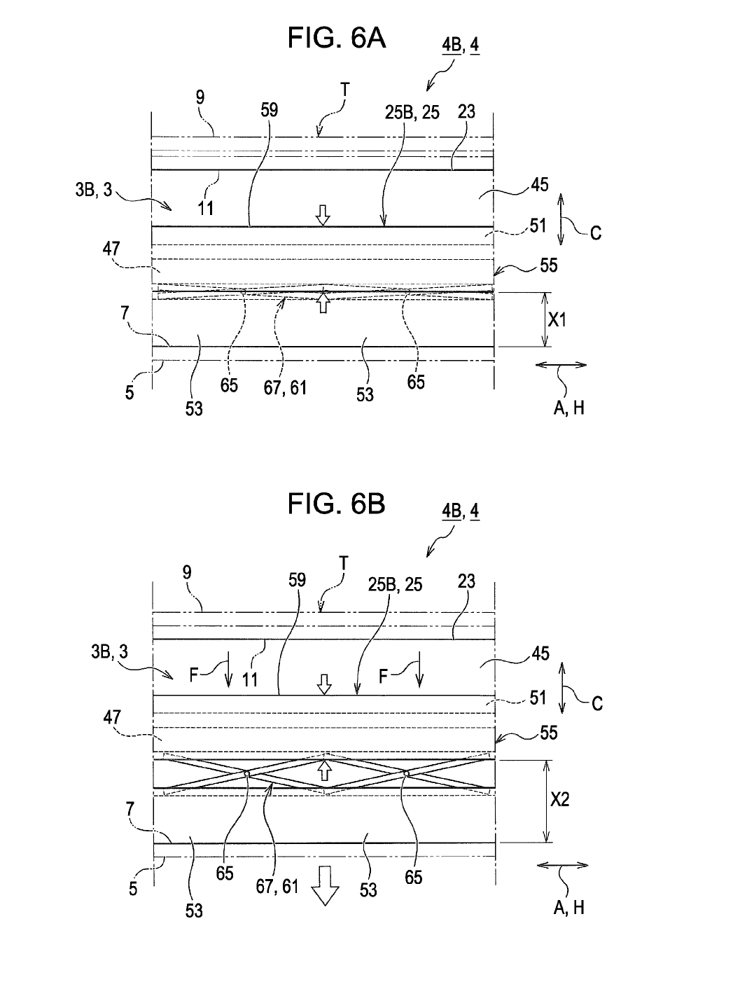

### See FIGS. 5A, 5B and FIGS. 6A, 6B

A print-target fabric supporting device 4B according to a second embodiment of the invention is a device such that the contact portions 53 in the print-target fabric supporting device 4A of the first embodiment are configured to be capable of being extended in a direction in which wrinkles in a print-target fabric T are smoothed out, so as to correspond to a larger-sized print-target fabric T.

Accordingly, descriptions of the configurations common to the first and second embodiments are omitted, and configurations specific to the second embodiment and different from the first embodiment will be mainly described hereinafter.

That is, this embodiment is configured such that the frame component 55 of a holding member 25B includes a main frame unit 59 having the engagement step portion 51 in an integrated manner, the contact portion 53 capable of moving in an extension direction of a print-target fabric T with respect to the main frame unit 59, and an extension mechanism 61 that connects the main frame unit 59 with the contact portion 53.

As the extension mechanism 61, a helical compression spring 63 as shown in FIGS. 5A and 5B, a plate spring, an elastic rubber or foamed material, or the like can be used. In addition, the extension mechanism 61 that adopts a link mechanism such as an intersecting link mechanism 67 connected by a connecting pin 65 as shown in FIGS. 6A and 6B, a cam mechanism or the like can be also used.

Note that in the case where a print-target fabric T is held by the print-target fabric supporting device 4B according to the embodiment configured as described above, the same operations are carried out as those of FIGS. 2 and 3 indicating the operations of the first embodiment.

However, with the operations having been described so far, the first surface 9 of the print-target fabric T is not sufficiently stretched, and in turn, wrinkles, sags and the like are generated in the first surface 9 as shown in FIG. 5A and FIG. 6A.

Accordingly, in this embodiment, the contact portion 53 is displaced in the extension direction using the extension mechanism 61 as shown in FIGS. 5B and 6B. With this, the displacement amount is changed from X1, which is a value before the contact portion 53 being extended as shown in FIGS. 5A and 6A, to X2, which is a value after the contact portion 53 being extended as shown in FIGS. 5B and 6B. This generates an increase in displacement amount of X2-X1 so that a tension force F according to the increase in displacement amount is exerted on the first surface 9 of the print-target fabric T as shown in FIGS. 5B and 6B in the manner indicated by the arrows F in the drawings.

Therefore, with the print-target fabric supporting device 4B according to the embodiment configured in this manner described above, the same action and effect can be also obtained as those of the first embodiment. Further, since the size of a print-target fabric T to be printed on can be enlarged with a single-sized base unit 3B and a single-sized holding member 25B, troublesome work of replacement of the base unit 3B and the holding member 25B every size of the print-target fabric T is reduced.

### Third Embodiment

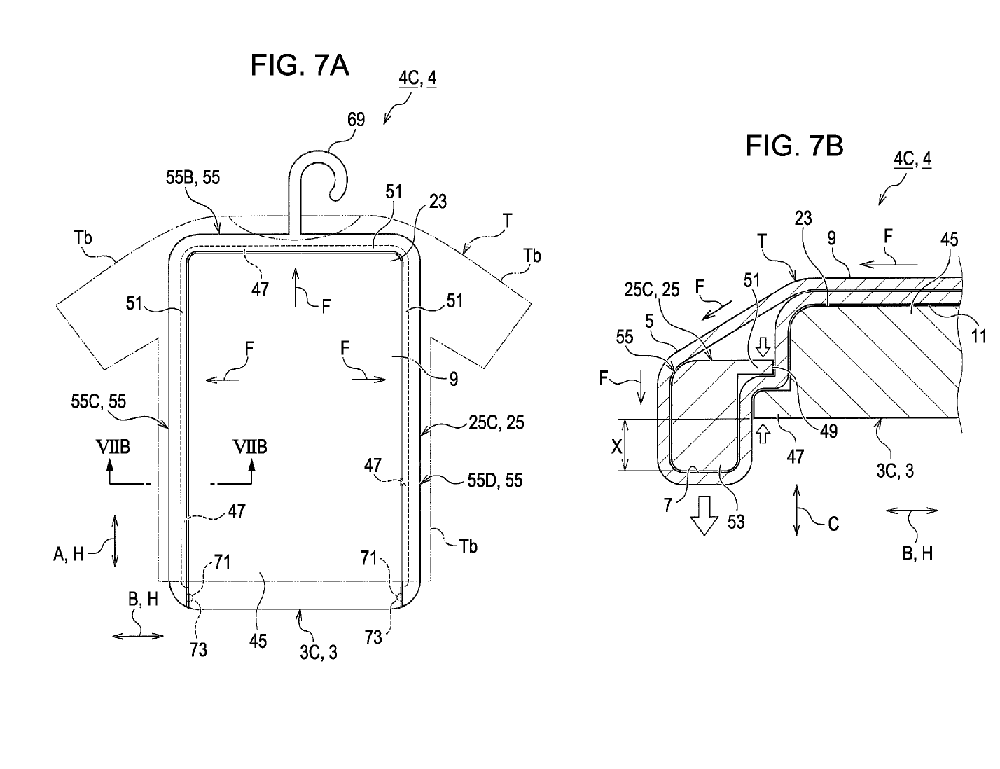

### See FIGS. 7A and 7B

A print-target fabric supporting device 4C according to a third embodiment of the invention is a device in which a holding member 25C is provided in a detachable manner, that is, provided separately from a base unit 3C. Further, the holding member 25C is configured such that the frame components 55 are provided at only three sides excluding the frame component 55A at a rotation base side among the four sides of the holding member 26C.

In addition, a hanger portion 69 that can hang a print-target fabric T with the holding member 25C wearing the print-target fabric T is provided on the frame component 55B at a rotation free end side as shown in FIG. 7A.

Since other constituent elements are the same as those of the first embodiment, descriptions of the configurations common to the first and the third embodiments are omitted, and configurations specific to the third embodiment and different from the first embodiment will be mainly described hereinafter.

That is to say, in this embodiment, the holding member 25C is provided separately from the base unit 3C as described earlier. To be more specific, positioning projections 71 formed in a hemispherical shape are provided as an example of a constituent element that also functions as the rotational shaft 27 at the time of engagement, on inner surfaces toward the rotation base side of the frame components 55C and 55D on the left and right of the holding member 25C respectively.

Further, the holding member 25C is configured by the three frame components, i.e., 55B on the rotation free end side, 55C on the left side and 55D on the right side. In other words, the holding member 25 is formed in a gate-like shape in which a side on the rotation base side is omitted.

Furthermore, at the center of the frame component 55B on the rotation free end side, there is formed the hanger portion 69 that has a hook-like shape and extends outward from the outer surface side of the frame component 55B along a horizontal direction H that intersects with the fitting direction C.

With the print-target fabric supporting device 4C according to the embodiment configured as described above, when a procedure in which a print-target fabric T is pre-processed, stored and moved, the holding member 25C is attached to the base unit 3C, and then the print-target-fabric T is held is carried out, the following are carried out.

First, when the print-target fabric T is to be pre-processed, the holding member 25C wearing the print-target fabric T is carried and hung, making use of the hang portion 69, at a position where the pre-processing is executed; then the pre-processing is executed on the first surface 9 of the print-target fabric T before ink jet printing which is subsequently executed.

The print-target fabric T having been pre-processed is stored in a state where the fabric is hung, making use of the hang portion 69, on a bar for hanging or the like that is horizontally spanned. When the print-target fabric T having been stored is taken out so as to be performed ink jet printing, the whole holding member 25C including the fabric is carried using the hang portion 69 to the set position S of the ink jet printing apparatus 1.

When the holding member 25C is to be set to the base unit 3C, the positioning projections 71 provided on the holding member 25C side are fitted into positioning recesses 73 formed at the right and left sides toward the end side of the base unit 3C so as to adjust the positions thereof. Thereafter, a procedure in which the holding member 25C is attached to the base unit 3C, wrinkles in the print-target fabric T are smoothed out, and the print-target fabric T is held, is carried out in the same manner as in the first embodiment.

Accordingly, with the print-target fabric supporting device 4C according to the embodiment configured in this manner described above, the same action and effect as those of the first embodiment can be also obtained. Further in this embodiment, because the print-target fabric supporting device 4C can store the holding member 25C beforehand in a state where the holding member 25C can be immediately attached to the base unit 3C, it is possible to respond to a case where a larger number of print-target fabrics T are needed to be printed efficiently through the setting operation being carried out smoothly.

By making use of the hang portion 69, an advantage can be obtained such that the position of a print-target fabric T can be easily adjusted when setting the print-target fabric T. For example, through setting the print-target fabric T symmetrically with the hanger portion 69 to be centered, the center position of the print-target fabric T can be easily adjusted in comparison with a case where there is no hanger portion.

### Fourth Embodiment

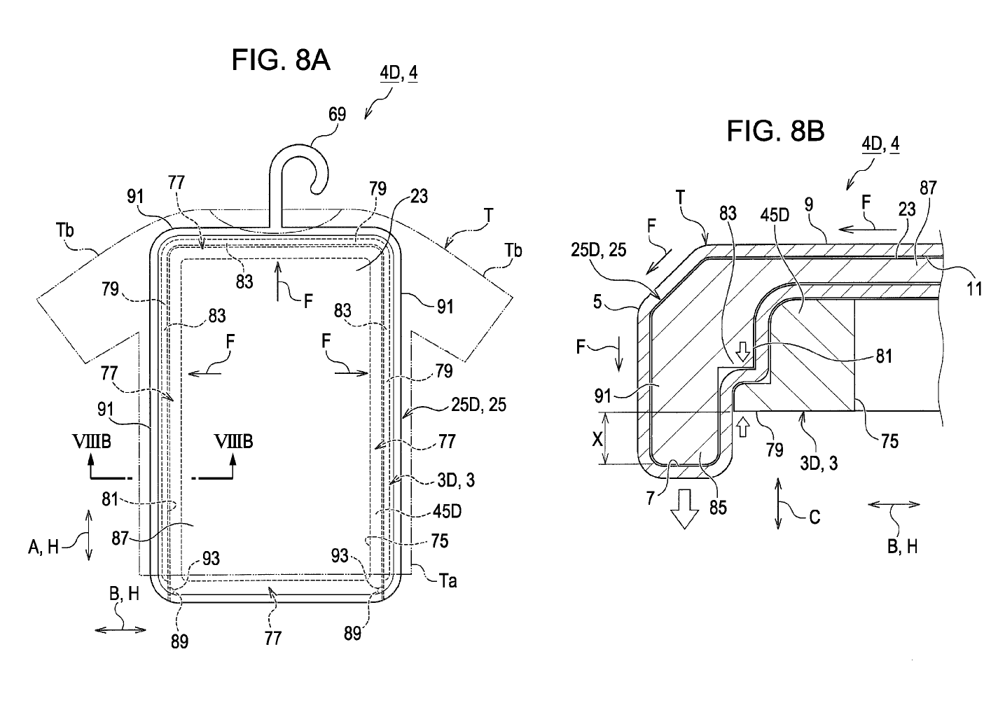

### See FIGS. 8A and 8B

A print-target fabric supporting device 4D according to a fourth embodiment of the invention is a device such that it differs from the print-target fabric supporting device 4C of the third embodiment in that a holding member 25D is configured by a sheet-like element and a base unit 3D is configured by a frame element. Other constituent elements are the same as those of the third element.

Therefore, descriptions of the configurations common to the third and fourth embodiments are omitted, and configurations specific to the fourth embodiment and different from the third embodiment will be mainly described hereinafter.

That is to say, in the fourth embodiment, an opening 75 is formed across a wide area at the center portion of a fitting protrusion 45D of a base unit 3D, and the fitting protrusion 45D is configured of a frame element whose four sides are enclosed by frame components 77 in a rectangular shape. At the lower portion of outer circumferential surfaces of the frame components 77 on the rotation free end side and the right and left end sides, an engagement border portion 79 having an outside flange shape and sticking outward in the horizontal direction H is formed.

Further, at the right and left end sides of the outer surface of the remaining frame component 77 on the rotation base side, positioning recesses 89 each of which is cut out in a hemispherical shape are formed like in the third embodiment.

Meanwhile, in the holding member 25D, border portions 91 are formed at three sides, i.e., the rotation free end side and the right and left end sides, extending downward in the fitting direction C; and an inner space surrounded by the border portions 91 at the three sides is a recess 81 that fits onto the fitting protrusion 45D of the base unit 3D.

Further, in each of the border portions 91 at the three sides, there are provided an engagement step portion 83 that engages with an engagement border portion 79 of the base unit 3D and a contact portion 85 that makes contact with the inner surface 7 at an end of the mounted print-target fabric T.

On each of the inner wall surfaces of the border portions 91 at the right and left end sides, there is formed a positioning projection 93, at a position toward the rotation base side, that has a hemispherical shape sticking out inward along the horizontal direction H, and fits into the positioning recess 89 of the base unit 3D.

On the upper side of the recess 81, a top board 87 having a flat upper surface is formed, and this upper surface of the top board 87 is the print surface formation portion 23 that supports the inner surface 7 which is the reverse side of the first surface 9 of the print-target fabric T. Accordingly, in this embodiment, the inner surface 7 which is the reverse side of the first surface 9 of the print-target fabric T is the second surface 11.

With the print-target fabric supporting device 4D according to the embodiment configured as described above, when a procedure in which a print-target fabric T is pre-processed, stored and moved, the holding member 25D is attached to the base unit 3D, and the print-target-fabric T is held, is carried out, it is carried out in the same manner as that of the print-target fabric supporting device 4C of the third embodiment.

With the device according to the embodiment configured as described above, the same action and effect as those of the third embodiment can be also obtained.

### Other Embodiments

The print-target fabric supporting device 4 and the ink jet printing apparatus 1 according to the invention are configured in this manner as described thus far in principle. However, it is needless to say that variations, omissions, or the like can be made partly in the configurations thereof without departing from the spirit and scope of the invention.

For example, in place of the configuration described in the first and second embodiments in which the holding member 25 is connected to the base unit 3 in a swingable manner while part of the holding member 25 being connected to the base unit 3 or an appropriate support member, it is possible to employ various configurations such as a configuration in which the holding member 25 is linearly moved in a sliding direction with respect to the base unit 3, a configuration in which the holding member 25 is moved in an oblique or curved manner while maintaining a parallel state thereof, and so on.

In addition, as an example of a mechanism that connects the holding member 25 with the base unit 3, a mechanism making use of crank mechanism, cam mechanism or the like can be cited and used. Further, a mechanism that drives rack and pinion mechanism or the like by an electric motor, a mechanism making use of a pneumatic cylinder or the like, and so on can be combined and provided as a mechanism that assists the movement of the holding member 25.

As a positioning structure when the holding member 25 and the base unit 3 are provided separately from each other as in the third and fourth embodiments, the positioning structure is not limited to a configuration that uses the positioning projections 71, 93 and the positioning recesses 73, 89 which are adopted in the third and fourth embodiments, and a mechanism in which other guide members such as a guide rail, a guide rod, a positioning pin and the like are used may be employed.

In the case where the positioning of the base unit 3 and the holding member 25 is determined only by fitting the fitting protrusion 45 or 45D of the base unit 3 to the window portion 49 or the recess 81 of the holding member 25, the positioning structure mentioned above can be omitted.

As a configuration in which the contact portions 53, 85 are extended in a direction where wrinkles in a print-target fabric T are smoothed out, the configuration is not limited to the configuration in which the contact portion 53 is displaced in the fitting direction C as described in the second embodiment, and it is possible to exert the tension force F on the print-target fabric T by sticking out the contact portion 53 outward in the horizontal direction H in a paralleled or slightly inclined manner.

Further, the engagement step portions 51, 83 and the contact portions 53, 85 may be provided on at least a pair of the opposing frame elements 55, 77 or the opposing border portions 91.

1-20. (canceled)

21. A print-target fabric supporting device comprising:
a holding member that holds a print-target fabric, and
a print surface formation portion that forms a print surface for discharging ink to the print-target fabric held by the holding member,
wherein the holding member has a hanger portion that can hang the holding member.

22. The print-target fabric supporting device according to claim 21, wherein the holding member is configured to be detachable.

23. The print-target fabric supporting device according to claim 21, wherein the holding member has the print surface formation portion.

24. The print-target fabric supporting device according to claim 21, further comprising:
a base unit that has the print surface formation portion,
wherein the holding member is configured to be detachable from the base unit.

25. The print-target fabric supporting device according to claim 21, wherein the hanger portion has a hook-like shape.

26. A printing apparatus comprising:
the print-target fabric supporting device according to claim 21.

27. A manufacturing method for a fabric, in which the printed fabric is manufactured using the printing apparatus according to claim 26.
